(19) United States
(12) Patent Application Publication
(10) Pub. No.: US 2015/0339784 A1
(43) Pub. Date: Nov. 26, 2015

(54) Avatar Service for Multi-Channel Systems With Full-Scale Business Context Sensitivity

(71) Applicant: International Business Machines Corporation, Armonk, NY (US)

(72) Inventors: Elson Zhendong Bao, Marietta, GA (US); Deenadayalan Janarthanam, Tallahassee, FL (US); Siva P. Kantamneni, Largo, FL (US)

(73) Assignee: International Business Machines Corporation, Armonk, NY (US)

(21) Appl. No.: 14/286,078

(22) Filed: May 23, 2014

(51) Int. Cl. G06Q 50/00; H04L 29/08

(52) U.S. Cl. CPC G06Q 50/01; H04L 67/306

(57) ABSTRACT

Handling changes in business context for a plurality of users in a multi-channel interactive information environment having a business context manager, an avatar service having a plurality of avatar service instances associated with the plurality of users, and a user information manager managing user preferences associated with the plurality of users.

### BACKGROUND

The present invention relates to an avatar service, and more specifically to an impersonation service for multi-channel systems with fill scale business context sensitivity.

In user interfacing systems, the quality of a user's experience depends on an organization's system sensitivity to business context information and the organization's system capability in using such information for intelligent interaction with the users. Existing solutions are either transaction-based or event-triggered, in which application of intelligence by the system is limited to front-end-triggered user interface events during an online transaction between the system and the user or to a simple 1-to-n relationship between backend non-user interface events and user-interacting actions. The organization's system focus on the user's needs is limited to the time during online transactions between the system and the user.

In certain business contexts, such as of airlines, cruise lines, time-shares and other businesses in the distribution sector, the user's or customer's needs are sensitive and vary in a business context during different stages of business service and interaction with the organization's system.

Systems of an organization include high interoperability and connectivity to other systems which are present internally and external to an organization. With higher interoperability and connectivity available, real-time signals may be detected, received or captured for message and event management. The relationship between the large quantity of information from the real-time signals and business logic used by the system to provide the user experience is complicated and complex and difficult for the system to handle when using an event triggered solution.

### SUMMARY

According to one embodiment of the present invention, a method of handling changes in business context for a plurality of users in a multi-channel interactive information environment having a business context manager, an avatar service having a plurality of avatar service instances associated with the plurality of users, and a user information manager managing user preferences associated with the plurality of users. The method comprising the steps of: the business context manager receiving at least a new message or event information with a business context change for a user associated with an avatar service instance; the business context manager determining that the business context change requires a response, and that the user with which the avatar service instance is associated is not available to provide instructions to respond to the business context change; the business context manager sending a message or event to the avatar service instance associated with the user; the avatar service instance consulting the user information manager for user preferences associated with the user; and the avatar service instance using the user preferences associated with the user to respond to the business context change by sending a change on behalf of the user to the business context manager.

According to another embodiment of the present invention, a computer program product for handling changes in business context for a plurality of users in a multi-channel interactive information environment having a business context manager, an avatar service having a plurality of avatar service instances associated with the plurality of users, and a user information manager managing user preferences associated with the plurality of users. The computer program product comprising: a computer readable storage medium having program instructions stored thereon: first program instructions executable by the business context manager, to cause the business context manager to: receive at least a new message or event information with a business context change for a user associated with an avatar service instance; determine that the business context change requires a response, and that the user with which the avatar service instance is associated is not available to provide instructions to respond to the business context change; and send a message or event to the avatar service instance associated with the user; second program instructions executable by the avatar service instance to cause the avatar service instance to: consult the user information manager for user preferences associated with the user; and use the user preferences associated with the user to respond to the business context change by sending a change on behalf of the user to the business context manager.

According to another embodiment of the present invention, a computer system for of handling changes in business context for a plurality of users in a multi-channel interactive information environment having a business context manager, an avatar service having a plurality of avatar service instances associated with the plurality of users, and a user information manager managing user preferences associated with the plurality of users comprising a computer comprising at least one processor, one or more memories, one or more computer readable storage media having program instructions executable by the computer to perform the program instructions. The computer system comprising: receiving, by the business context manager, at least a new message or event information with a business context change for a user associated with an avatar service instance; determining, by the business context manager, that the business context change requires a response, and that the user with which the avatar service instance is associated is not available to provide instructions to respond to the business context change; sending, by the business context manager, a message or event to the avatar service instance associated with the user; consulting, by the avatar service instance, the user information manager for user preferences associated with the user; and using, by the avatar service instance, the user preferences associated with the user to respond to the business context change by sending a change on behalf of the user to the business context manager.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a schematic of avatar service components and their relationships according to an illustrative embodiment.

FIG. 3 shows a schematic of a state transition of the avatar service according to an illustrative embodiment.

FIGS. 4A-4C shows a flow diagram of a method of integrating an avatar service with business context sensitivity.

FIG. 5 illustrates internal and external components of a client or device computer and a server computer in which illustrative embodiments may be implemented.

### DETAILED DESCRIPTION

In an illustrative embodiment of the present invention, the avatar service considers the needs of the user it represents by being sensitive to relevant changes in business context throughout an e-commerce experience of the user. The system uses user information to respond to the relevant changes in business context, providing value to the user's experience.

In an illustrative embodiment of the present invention, the avatar service is connected to and interacts with a multi-channel interactive information environment. The avatar service reacts to the information received from the multi-channel interactive information environment.

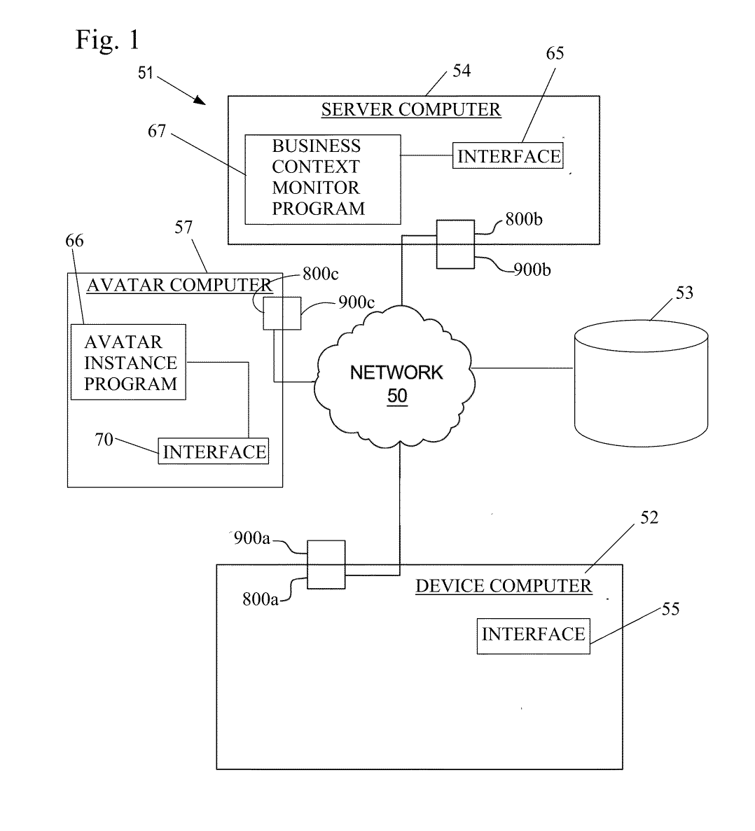

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, an avatar computer 57, a repository 53, and a server computer 54 connect to network 50. Also connected to a network may be message queues, listings or channels of schedule events, and monitoring services. In other exemplary embodiments, network data processing system 51 may include additional client or device computers, storage devices or repositories, avatar computers, server computers, and other devices not shown.

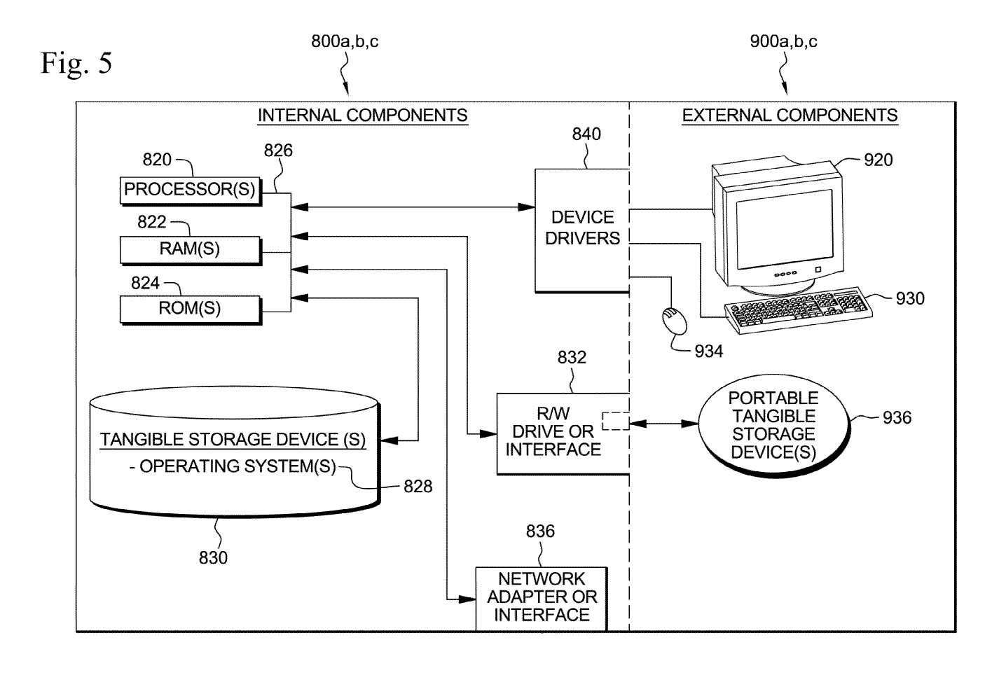

Device computer 52 includes a set of internal components 800a and a set of external components 900a, further illustrated in FIG. 5. Device computer 52 may be, for example, a mobile device, a cell phone, a personal digital assistant, a netbook, a laptop computer, a tablet computer, a desktop computer, or any other type of computing device.

Device computer 52 may contain an interface 55. The interface 55 may accept commands and data entry from a user. The interface 55 can be, for example, a command line interface, a graphical user interface (GUI), or a web user interface (WUI) through which a user can access their profile associated with their avatar on the avatar computer 57 as shown in FIG. 1, or alternatively on server computer 54 or avatar computer 57.

Server computer 54 includes a set of internal components 800b and a set of external components 900b illustrated in FIG. 5. The server computer 54 may contain an interface 65. The interface 65 may accept commands and data entry. The interface 65 can be, for example, a command line interface, a graphical user interface (GUI), or a web user interface (WUI). The server computer 54 preferably includes a business context monitor program 67.

Avatar computer 57 includes a set of internal components 800c and a set of external components 900c illustrated in FIG. 5. The avatar computer 57 may contain an interface 70. The interface 70 may accept commands and data entry. The interface 70 can be, for example, a command line interface, a graphical user interface (GUI), or a web user interface (WUI). The server computer 70 preferably includes an avatar instance program 66. While not shown, it may be desirable to have the avatar instance program be present on the server computer 54.

In the depicted example, server computer 54 provides information, such as boot files, operating system images, and applications to device computer 52 and avatar computer 57. Server computer 54 can compute the information locally or extract the information from other computers on network 50.

Program code and programs such as a business contact monitor program 67 and/or avatar instance program 66 may be stored on at least one of one or more computer-readable tangible storage devices 830 shown in FIG. 5, on at least one of one or more portable computer-readable tangible storage devices 936 as shown in FIG. 5, on repository 53 connected to network 50, or downloaded to a data processing system or other device for use. For example, program code and programs such as a business contact monitor program 67 and/or avatar instance program 66 may be stored on at least one of one or more tangible storage devices 830 on server computer 54 and downloaded to avatar computer 57 over network 50 for use on an avatar computer 57. Alternatively, server computer 54 can be a web server, and the program code and programs such as a business contact monitor program 67 and/or avatar instance program 66 may be stored on at least one of the one or more tangible storage devices 830 on server computer 54 and accessed on the avatar computer 57 or device computer 52. Business contact monitor program 67 and/or avatar instance program 66 can be accessed on device computer 52 through interface 55. In other exemplary embodiments, the program code and programs such as a business contact monitor program 67 and/or avatar instance program 66 may be stored on at least one of one or more computer-readable tangible storage devices 830 on avatar computer 57 or distributed between two or more servers.

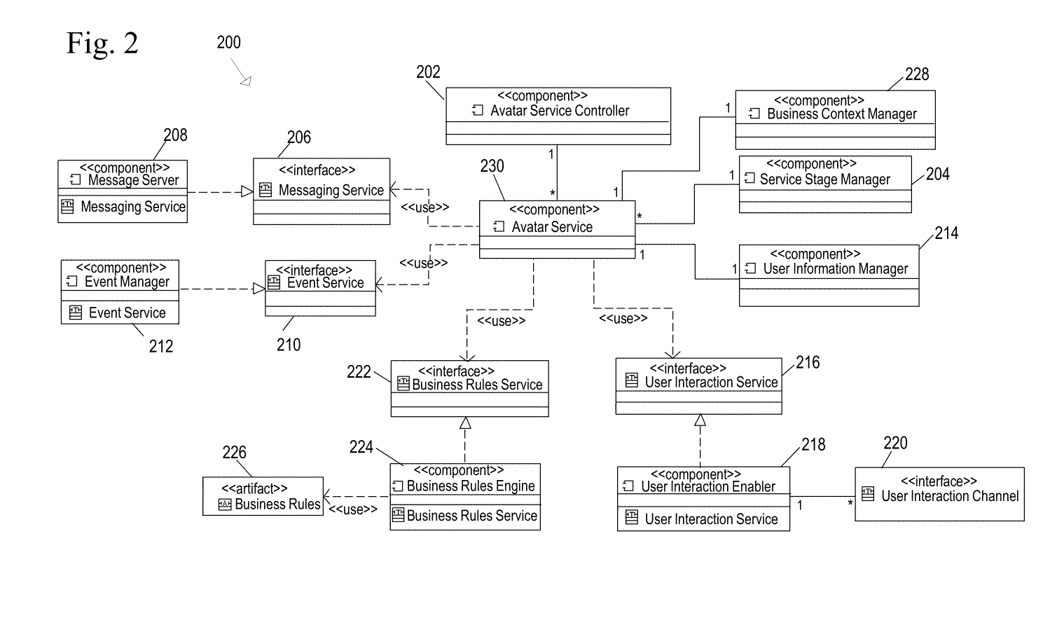

FIG. 2 shows a schematic of avatar service components and their relationships according to an illustrative embodiment.

The avatar service 200 has an avatar service component 230. An avatar service controller 202 is bi-directionally associated with one or more avatar service components 230. The avatar service component 230 is bi-directionally associated with one or more service stage manager components 204. The avatar service component 230 is also bi-directionally associated with a business context manager 228. The business context manager has access to business context for multiple businesses and include business context as it relates to e-commerce and the user. The business context could be any factor, such as who, when, where, how, why, and what is related to business value and customer satisfaction of business products or services. These factors may affect business value and customer satisfaction during different stages of a user's e-commerce experience, for example shopping and booking of a package, which may include travel, experience on a specific date, or a combination of multiple components.

The avatar service component 230 has a user information manager component 214. The user information manager component 214 may have access to information regarding the user, for example preferences, payment information, contact information such as address, e-mail, phone number, decisions regarding specific situations, etc., and restricts access to this information as necessary and designated by the user. The information includes details regarding how the user will be represented by the avatar service component 230. The user information may be stored within a repository, for example repository 53. The origin of the user information may be from registration of the user, history or previous interaction between the user and the avatar service 200, or from an available third party channel.

The avatar service component 230 uses a messaging service interface 206 to interface with the message server component 208 with messaging service operations.

The avatar service component 230 uses an event service interface 210 to interface with event manager component 212 with event service operations.

The messaging service operations and the event service operations in which the avatar service component 230 uses represent a multi-channel interactive information environment.

The avatar service component 230 also uses a business rules service 222 to interface with a business rules engine component 224 with business rules service operation. The business rules engine component 224 uses business rules artifact 226. The business rules artifact may include rules that constrain some aspect of a business or defines part of a process of the business, for example operations. The business rules may apply to people, processes, corporate behavior and computing systems in an organization.

The avatar service component 230 additional uses a user interaction service interface 216 to interface with a user interaction enabler component 218 with user interface service operations. The user interaction enabler component 218 is bi-directionally associated with one or more user interaction channel interfaces 220.

The avatar instance program 66 and the business context monitoring program may both be controlled by the avatar service component 230.

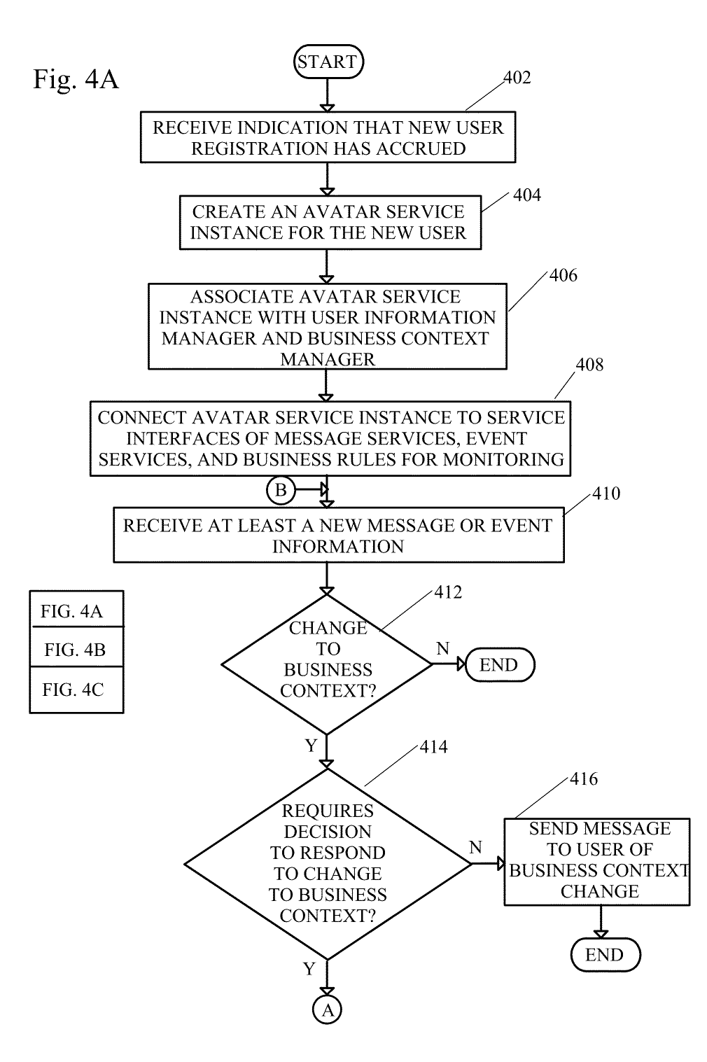

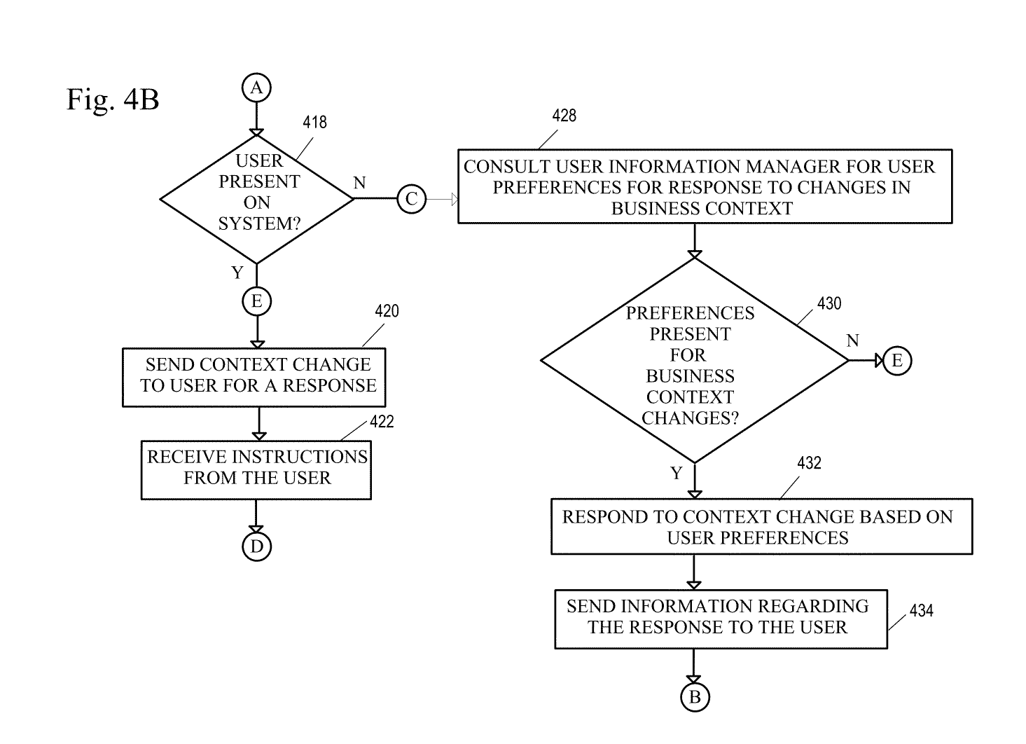

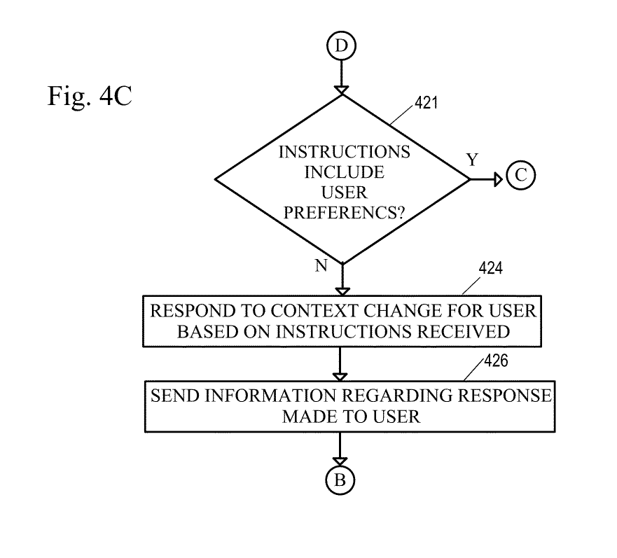

FIGS. 4A-4C show a flow diagram of a method of integrating an avatar service with business context sensitivity.

In a first step, the avatar service controller component 202 through the avatar instance program 66 receives an indication that a new user registration has accrued (step 402). The registration preferably includes user information details that may include, but are not limited to preferences, payment information, contact information such as address, e-mail, phone number, etc., that are provided through an interface, for example interface 55 of FIG. 1.

Next, the avatar service controller component 202 creates an avatar service instance associated with the new user (step 404), for example through the avatar instance program 66. The avatar service controller component 202 creates an avatar service component 230.

The avatar service controller component 202 associates the avatar service instance with the user registration information and preferably the user information manager component 214 and the business context manager 228 (step 406), for example through the avatar instance program 66. The avatar service instance is also preferably associated with a service stage manager component 204.

The avatar service controller component 202 connects the avatar service instance to messaging services, event services, and business rules for monitoring (step 408), for example through the business context monitor program 67. The amount of monitoring and/or the sensitivity context within the messages and events may increase as the time frame is decreased to the event or service the user has purchased.

The avatar service instance 230 receives at least a new message or event from the messaging service or the event service with information regarding business context (step 410), for example by a business context manager 228 running the business context monitor program 67 through the messaging service interface 206 and/or the event service interface 210.

The message may take numerous forms, which may include, but is not limited to: instant messaging or real-time text transmission over the Internet between two parties or multiple parties; personal messaging in a social platform or private messaging service; electronic mail; text messaging; or messages posted to a website, blog, bulletin board system, internet forum or newsgroup.

If there is no change to the business context as it relates to the user (step 412), the method ends.

If there is a change to the business context as it relates to the user (step 412), and the change does not require a decision to respond to the change in the business context (step 414), the method ends. Alternatively, the change to the business context may be sent to the user (step 416), for example by the business context monitor program 67.

If there is a change to the business context as it relates to the user (step 412), and the change does require a decision to respond to the change in the business context (step 414), the business context monitor program 67 determines whether the user is currently logged into the system (step 418).

If the user is present on the system (step 418), the change in business context is sent to the user for a response or instructions (step 420), for example by the business context monitor program 67. The response or instructions from the user are received (step 422). If the response from the user that was received does not include additional user preferences (step 421), the business context change is responded to, for example by the business context monitor program 67, using the response provided by the user (step 424) and a notification regarding the actions taken to the change in business context is sent to the user (step 426), for example by the business context monitor program 67. The method then returns to step 410 of receiving a new event or message.

If the response from the user that was received does include additional user preferences (step 421), the user information manager for the user is consulted for preferences in responding to a business context change (step 428), for the by the avatar instance program 66. The business context change is then responded to (step 432), for example by the business context monitor program 67, using the preferences established by the user and a notification regarding the actions taken to the change in business context is sent to the user (step 434), for example by the business context monitor program 67. The method then returns to step 410 of receiving a new event or message.

If the user is not present on the system (step 418), the user information manager for the user is consulted for preferences in responding to a business context change (step 428), for the by the avatar instance program 66.

If preferences are not present for changes in context (step 430), the change in business context is sent to the user for a response or instructions (step 420), for example by the business context monitor program 67. The response or instructions from the user are received (step 422). If the response from the user that was received does not include additional user preferences (step 421), the business context change is responded to, for example by the business context monitor program 67, using the response provided by the user (step 424) and a notification regarding the actions taken to the change in business context is sent to the user (step 426), for example by the business context monitor program 67. The method then returns to step 410 of receiving a new event or message.

If the preferences are present for changes in context (step 430), the business context change is responded to (step 432), for example by the avatar service instance program 66, using the preferences established by the user and a notification regarding the actions taken to the change in business context is sent to the user (step 434), for example by the business context monitor program 67. The method then returns to step 410 of receiving a new event or message.

It should be noted that steps 424-426 may be replaced with a step of the response being performed solely by the user.

Furthermore, if the response in step 422 only included additional preferences, the method would then continue at step 428.

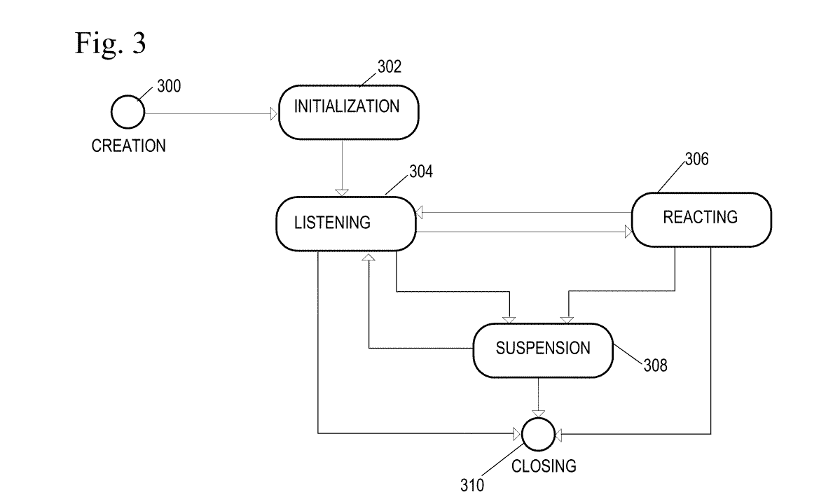

FIG. 3 shows a schematic of a state transition of the avatar service instance according to an illustrative embodiment. An instance of the avatar service 230 is created 300 and initialized 302, for example through steps 402-406 of FIG. 4A. After initialization 302, the instance of the avatar service 230 listens and receives messages 304 through message services, event services and is also connected to business rules, for example through steps 408 of FIG. 4A. The avatar service reacts 306 to the messages or events received depending on the information obtained during listening 304, for example through steps 412-432 of FIGS. 4A-4C. The reaction of the avatar service is a reactive decision making process that may be implemented in a number of ways, for example including, but not limited to a decision table, deductive machine, a rules engine and hard-coded program.

The avatar service may also suspend 308 while waiting to receive information, for example for step 422 of FIG. 4B. The avatar service would then close or end 310 after the user has been notified of a response and until a new message or event information where to be detected through monitoring.

For example, suppose a user has previously registered and created an avatar service instance, and has supplied user information about the user's preferences and needs, which the avatar service instance has provided to the user information manager for storage in a repository.

At some time after registering, the user books a flight with an airline for example from Ithaca, N.Y., to Tampa, Fla., with a stop in Charlotte, N.C., for a date two months later.

Because of a change in the airline's structure, a month after the booking was made, the airline has closed its hub in North Carolina and no longer connects through Charlotte for flights from Ithaca. The original flight has therefore been canceled. The airline offers either a flight connecting through La Guardia Airport in New York, with a three hour layover and a total time from Ithaca to Tampa of seven hours, or a flight with two connections in Philadelphia, Pa., and Atlanta, Ga., with two one-hour layovers and a total flight time of five hours.

Through the monitoring of an event service by the business context monitor program 67, this change in flight availability is noted. The business rules instruct the business context manager to ask for a choice when there is a change in context of this kind. The user is not signed onto the system, so the business context manager cannot ask the user directly which flight the user would prefer. Since the business context has changed regarding the user (the flight is no longer available), the business context monitor program 67 asks the avatar instance program what the customer would want to do, if the customer were being asked directly.

The avatar instance program consults the user information manager for any user information which would indicate how the user may wish to respond to this change. For the purpose of this example, the user has indicated that she prefers fewer connections more than shortest elapsed time, and she has indicated that she does not wish to fly through Atlanta under any circumstances. She has indicated that she will not accept a layover shorter than forty-five minutes (for fear of missing connections) or longer than four hours (for fear of boredom).

Using these preferences, the avatar instance program can determine that the user's flight selection would be the La Guardia flight if presented with this choice, since the other flight has two connections and goes through Atlanta. The avatar instance program sends a message to the business context monitor program, instructing it to book tickets on the La Guardia flight.

If there was not enough user information available from the user information manager for the avatar instance program to make a decision, it sends a message to the business context monitor program 67 indicating it cannot make a choice. The business context monitor program would notify the user that more information regarding her preferences is needed, or, alternatively, the business context monitor program 67 can simply ask the user to make the choice herself. Given a choice, the business context monitor program 67 can take the action as designated by the user, or, if the user has added preference information, the business context monitor program can re-message the avatar instance program after the information was received to have it consult the user information and see if it can make a decision.

It should be noted that as the date of the actual flights were to become closer or within a certain time frame, the amount of monitoring may increase or may become more sensitive in nature. In other words, the avatar instance program of the avatar service instance alters the monitoring and response while representing the user to the air travel at 72 hours prior to departure, 24 hours prior to departure, within 24 hours of departure and within 2 hours of departure.

FIG. 5 illustrates internal and external components of device computer 52, an avatar computer 57, and server computer 54 in which illustrative embodiments may be implemented. In FIG. 5, device computer 52, avatar computer 57, and server computer 54 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, business context monitor program 67 and avatar instance program 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Business context monitor program 67 and avatar instance program 66 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Business context monitor program 67 and avatar instance program 66 can be downloaded to the device computer 52, the avatar computer 57, and server computer 54 from an external computer via a network (for example, the Internet, a local area network or other, wide area network) and network adapter or interface 836. From the network adapter or interface 836, business context monitor program 67 and avatar instance program 66 are loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Business context monitor program 67 and avatar instance program 66 can be written in various programming languages including low-level, high-level, object-oriented or non object-oriented languages. Alternatively, the functions of a business context monitor program 67 and avatar instance program 66 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method of handling changes in business context for a plurality of users in a multi-channel interactive information environment having a business context manager, an avatar service having a plurality of avatar service instances associated with the plurality of users, and a user information manager managing user preferences associated with the plurality of users, the method comprising the steps of:
the business context manager receiving at least a new message or event information with a business context change for a user associated with an avatar service instance;
the business context manager determining that the business context change requires a response, and that the user with which the avatar service instance is associated is not available to provide instructions to respond to the business context change;
the business context manager sending a message or event to the avatar service instance associated with the user;
the avatar service instance consulting the user information manager for user preferences associated with the user; and
the avatar service instance using the user preferences associated with the user to respond to the business context change by sending a change on behalf of the user to the business context manager.

2. The method of claim 1, further comprising the business context manager sending a notification to the user of the response made on behalf of the user regarding the business context change.

3. The method of claim 1, further comprising, before the first step, the steps of setting up a user in the environment, comprising:
a computer creating an avatar service instance for a new user;
the computer associating the avatar service instance for the new user with a user information manager and business context manager for managing business context changes; and
the computer connecting the avatar service instance to at least a service interface of at least one message service, to at least an event interface of at least one event service, and business rules.

4. A computer program product for handling changes in business context for a plurality of users in a multi-channel interactive information environment having a business context manager, an avatar service having a plurality of avatar service instances associated with the plurality of users, and a user information manager managing user preferences associated with the plurality of users, the computer program product comprising:
a computer readable storage medium having program instructions stored thereon:
first program instructions executable by the business context manager, to cause the business context manager to:
receive at least a new message or event information with a business context change for a user associated with an avatar service instance;
determine that the business context change requires a response, and that the user with which the avatar service instance is associated is not available to provide instructions to respond to the business context change; and
send a message or event to the avatar service instance associated with the user;
second program instructions executable by the avatar service instance to cause the avatar service instance to:
consult the user information manager for user preferences associated with the user; and
use the user preferences associated with the user to respond to the business context change by sending a change on behalf of the user to the business context manager.

5. The computer program product of claim 4, further comprising program instructions executable by the business context manager, to cause the business context manager to send a notification to the user of the response made on behalf of the user regarding the business context change.

6. The computer program product of claim 4, further comprising, before the first program instructions, program instructions by a computer to cause the computer to:
create an avatar service instance for a new user;
associate the avatar service instance for the new user with a user information manager and business context manager for managing business context changes; and
connect the avatar service instance to at least a service interface of at least one message service, to at least an event interface of at least one event service, and business rules

7. A computer system for of handling changes in business context for a plurality of users in a multi-channel interactive information environment having a business context manager, an avatar service having a plurality of avatar service instances associated with the plurality of users, and a user information manager managing user preferences associated with the plurality of users comprising a computer comprising at least one processor, one or more memories, one or more computer readable storage media having program instructions executable by the computer to perform the program instructions comprising:
receiving, by the business context manager, at least a new message or event information with a business context change for a user associated with an avatar service instance;
determining, by the business context manager, that the business context change requires a response, and that the user with which the avatar service instance is associated is not available to provide instructions to respond to the business context change;
sending, by the business context manager, a message or event to the avatar service instance associated with the user;
consulting, by the avatar service instance, the user information manager for user preferences associated with the user; and
using, by the avatar service instance, the user preferences associated with the user to respond to the business context change by sending a change on behalf of the user to the business context manager.

8. The system of claim 1, further comprising sending, by the business context manager, a notification to the user of the response made on behalf of the user regarding the business context change.

9. The system of claim 1, further comprising, before the program instructions, the program instructions of setting up a user in the environment, comprising:
creating, by a computer, an avatar service instance for a new user;
associating, by the computer, the avatar service instance for the new user with a user information manager and business context manager for managing business context changes; and
connecting, by the computer, the avatar service instance to at least a service interface of at least one message service, to at least an event interface of at least one event service, and business rules.
